(19) United States
(12) Patent Application Publication
(10) Pub. No.: US 2011/0082978 A1
(43) Pub. Date: Apr. 7, 2011

(54) NON-VOLATILE MEMORY

(75) Inventor: Yasuhiro TOMITA, Osaka (JP)

(73) Assignee: PANASONIC CORPORATION, Osaka (JP)

(21) Appl. No.: 12/968,827

(22) Filed: Dec. 15, 2010

Related U.S. Application Data
(63) Continuation of application No. PCT/JP2010/003415, filed on May 21, 2010.

(30) Foreign Application Priority Data
Jun. 15, 2009 (JP) 2009-142437

(51) Int. Cl. G06F 12/16

(52) U.S. Cl. 711/114; 711/E12.103

(57) ABSTRACT

In a non-volatile memory, external bit data whose opposite bit is in the programmed state is stored in a buffer, and is then programmed. A program level is increased in a stepwise manner every pulse. When the program level reaches a threshold voltage, unprogrammed data is stored into the buffer, and program operation is continued. Therefore, variations in a program characteristic which are caused by the programmed state of the opposite bit are reduced or prevented, thereby reducing or preventing the increase in the number of program pulses and the expansion of the threshold voltage distribution during program operation. As a result, lower-cost, higher-speed, and more highly reliable program operation is achieved.

### CROSS-REFERENCE TO RELATED APPLICATIONS

This is a continuation of PCT International Application PCT/JP2010/003415 filed on May 21, 2010, which claims priority to Japanese Patent Application No. 2009-142437 filed on Jun. 15, 2009. The disclosures of these applications including the specifications, the drawings, and the claims are hereby incorporated by reference in their entirety.

### BACKGROUND

The present disclosure relates to non-volatile memories including multi-bit cells, such as MONOS and the like, which can perform write operation at high speed and with high reliability using a buffer for program data.

Floating gate memories, which employ an electrical conductor, such as polysilicon or the like, as a material for accumulating bit information, have been the mainstream non-volatile memories, such as flash memory, EEPROM, and the like. In recent years, multi-bit MONOS type NROM memories made of an ONO film having a complex structure of a nitride film (insulator) and an oxide film have attracted attention as an alternative to the floating gate.

A structure of a typical NROM memory is shown in FIGS. 17A-17C. FIG. 17A shows a cross-sectional structure of a memory cell array. FIG. 17B shows a top view of the memory cell array. FIG. 17C shows an equivalent circuit of the memory cell array, corresponding to the top view.

In the NROM memory cell array, an ONO film 163 formed between each bit line 164 is an insulator, and therefore, opposite edges of the ONO film can serve as a single independent memory cell. By selectively injecting hot electrons into the opposite edges, a total of two bits can be stored (corresponding to accumulated charge 166 and 167).

Moreover, recently, by precisely controlling the charge injection level of each bit so that the bit has multiple levels, data of 2*n bits (n is a natural number) can be stored into one cell.

To inject hot electrons is called “program,” and a high threshold state of a cell caused by programming or program operation is called a “programmed state.” To inject hot holes by band-to-band tunneling is called “erase,” and a low threshold state (neutralized state of electrons in ideal conditions) caused by erasure or erase operation is called an “erased state.”

Program operation is performed while applying a high positive voltage to a word line and applying a high positive voltage pulse to a bit line (VPPD). Erase operation is performed while applying 0 V or a negative voltage to a word line and applying a high positive voltage pulse to a bit line (VPPD). Read operation is performed by reading out a cell current with a proper word line bias by so-called reverse read, i.e., setting a bias voltage between bit lines to have a polarity reverse to that during program operation.

The NROM memory has a feature that the threshold of one of the bits of a cell affects a program characteristic (programmability: a change in threshold with respect to a program pulse) of the other bit of the cell. As used herein, one of the bits facing each other of a cell that is opposite to the bit of interest is referred to as an “opposite bit.” When the opposite bit is in the programmed state, the bit of interest can be programmed using a lower bit line voltage than when the opposite bit is in the erased state.

Detailed device operation of the NROM memory is described in Japanese Translation of PCT International Application No. 2001-512290, U.S. Pat. No. 5,768,192, U.S. Pat. No. 6,011,725, and the like.

A method for changing the bias of program operation, depending on the programmed state of an opposite bit is described in International Publication WO2002/097821 and Ran Shahar, et al., “ISSCC 2008, Session 23, Non-Volatile Memory,” “A 4b/Cell 8 Gb NROM Data-Storage Memory with Enhanced Write Performance,” and the like

FIGS. 18A-18C shows characteristics of a typical NROM device. FIG. 18A shows a relationship between program pulse levels VPPD applied to the bit line and memory cell threshold voltages for a cell (P, 0) where the opposite bit is in the programmed state and a cell (P, 1) where the opposite bit is in the erased state. A level at which the threshold voltage starts to vary significantly is indicated by VPPDINIT1 for the cell (P, 0) where the opposite bit is in the programmed state and VPPDINIT2 the cell (P, 1) where the opposite bit is in the erased state. As can be seen from FIG. 18A, VPPDINIT1<VPPDINIT2.

In a typical non-volatile memory structure, a single voltage pulse can be applied to bit lines at a time. For example, if the initial voltage pulse of program is set to be the lower voltage VPPDINIT1, a pulse needs to be applied to both patterns of the cells (P, 0) and (P, 1) when the program pulse is low (VPPD<VPPDINIT2) as shown in FIG. 18B. Within this voltage range, however, the programmability of the cell (P, 1) is low, and the increase in the threshold voltage is small, and therefore, a program current is uselessly consumed. As a result, the number of cells (P, 0) to which a pulse is simultaneously applied decreases in a case where a limited current is available, and therefore, the number of times of application of a pulse increases. A pulse having an appropriate initial voltage value is, however, applied to each of the cells (P, 0) and (P, 1), and therefore, the distribution of threshold voltages after program operation converges.

Conversely, if the initial voltage of program is set to be the higher initial voltage VPPDINIT2 as shown in FIG. 18C so that the program speed is increased, the amount of injected charge slightly overshoots in the cell (P, 0) having a higher programmability, so that the distribution of threshold voltages has an elongated tail on a high potential side. The VPPD level and a programmability per pulse are, however, high, and therefore, the number of times of application of a pulse decreases.

It can be easily seen from the foregoing that, ideally, in order to achieve higher speed and a threshold voltage distribution having higher convergence performance, separate voltages which are determined, depending on the state of the opposite bit, may be simultaneously applied to bits which are to be simultaneously programmed.

It is, however, necessary to provide a circuit for generating a plurality of program voltages and add a function of switching voltages to a write driver, resulting in a larger, more complicated, and higher-cost circuit.

### SUMMARY

The present disclosure describes implementations of a non-volatile memory which achieves lower-cost, higher-speed, and more highly reliable program operation.

An example non-volatile memory includes a memory cell array including one or more non-volatile memory cells each including bits which accumulate charge in different areas of an charge accumulation layer, an address decoder configured to select one of the memory cells from the memory cell array, a write driver configured to write data to the selected memory cell, a sense amplifier configured to read out data from the selected memory cell, a buffer configured to supply write data to the write driver, and a data logic circuit configured to perform a calculation on different pieces of data stored in the buffer, and a calculation on a piece of data stored in the buffer and an output of the sense amplifier. At least one of an output of the data logic circuit and external data is input to the buffer.

With this configuration, subset data of the external data stored in the buffer can be easily generated.

Moreover, the data logic circuit selects a cell whose opposite bit is in a predetermined state based on the external data stored in the buffer and information about the corresponding opposite bit accessed from the memory array, and stores the external data back to the buffer. As a result, first subset data having the predetermined opposite bit state of the external data can be easily generated.

Moreover, by the data logic circuit performing a calculation on the external data stored in the buffer and the subset data, new second subset data can be similarly generated.

For example, the first subset data may be write data whose opposite bit is in the programmed state. The second subset data may be write data which is the first subset data of the desired external data from which a programmed bit(s) has been removed.

Moreover, program operation may be performed in accordance with a step algorithm in which the pulse level is increased in a stepwise manner every pulse. In this case, the program operation may include pulse application and verify operation which are performed based on the first subset data, and pulse application and verify operation which follow that pulse application and verify operation, and are performed based on the second subset data.

A condition for transition of pulse application from the first subset data to the second subset data may be a combination of any of passing verification, reaching a predetermined pulse level, and a predetermined number of pulses.

The first subset data is data whose opposite bits are all in the programmed state, and therefore, has high programmability. Therefore, all program pulses are effective to program operation.

The second subset data is data whose opposite bits are all in the erased state or are partially in the programmed state. For the second subset data, a pulse having an appropriate higher initial voltage can be applied to a cell whose opposite bit is in the erased state. There is, however, the possibility that a pulse has been applied to a cell whose opposite bit, to which a pulse is simultaneously applied, is in the programmed state in the case of the first subset data, and the cell is over-programmed. To reduce or avoid this, an initial pulse level applied to the second subset data may be lower than a value which is determined only based on the erasure of the opposite bit, or the step of the step algorithm at an initial pulse count may be smaller. None of program pulses applied to the second subset is useless.

According to an embodiment of the present disclosure, the non-volatile memory further includes a fourth data switch configured to select and input one of the output of the buffer and the external data to the data logic circuit.

With this configuration, while external data is stored into the buffer, the data logic circuit can select a cell whose opposite bit is in a predetermined state based on the external data and information about an opposite bit corresponding to the external data accessed from the memory array, and store the first subset data into the buffer.

It is not necessary to read out external data. Therefore, power consumption is reduced, and the generation of the first subset data is hidden in the time that it takes to load the external data to the buffer, resulting in higher-speed program operation.

According to an embodiment of the present disclosure, the non-volatile memory further includes a register configured to hold the output of the buffer, and the data logic circuit further performs a calculation on the output of the buffer and an output of the register.

With this configuration, a calculation on pieces of data required for the second data subset stored in the buffer can be achieved. Moreover, the calculation can be achieved using a single memory, resulting in a reduction in power consumption and area.

In addition, according to an embodiment of the present disclosure, in the non-volatile memory, the non-volatile memory cell accumulates charge at two portions of the charge accumulation layer, the two portions corresponding to a first bit and a second bit, and data stored in the buffer at a time corresponds to one of the first and second bits.

With this configuration, during application of a program pulse, the state of the opposite bit is not changed, and therefore, there are not variations in programmability which would otherwise be caused by changes in the state of the opposite bit. As a result, variations in program distribution can be reduced or prevented, whereby reliability can be improved.

According to an embodiment of the present disclosure, in the non-volatile memory, the calculation of the data logic circuit is at least an OR operation or an AND operation.

With this configuration, an OR or AND operation is performed on the external data and the first subset data whose opposite bit is in the programmed state, thereby easily generating the second subset data which is external data from which programmed bits of the first subset data have been removed.

Another example non-volatile memory of the present disclosure includes a memory cell array including one or more non-volatile memory cells each configured to accumulate charge at two portions of an charge accumulation layer, the two portions corresponding to a first bit and a second bit, an address decoder configured to select one of the memory cells from the memory cell array, a write driver configured to write data to the selected memory cell, a sense amplifier configured to read out data from the selected memory cell, a buffer configured to supply write data to the write driver, a register configured to hold an output of the buffer, a second data switch configured to select one of an output of the register and an output of the sense amplifier, a data logic circuit configured to perform a calculation on the output of the buffer and an output of the second data switch, and a first data switch configured to select and input one of the output of the data logic circuit and the external data to the buffer.

With this configuration, a calculation on pieces of data stored in the buffer can be easily achieved using a single memory. Moreover, by providing the first data switch which switches between the register and the sense amplifier output, a calculation on outputs of the sense amplifier and the register can be performed by additionally providing a minimum number of data switches.

Another example non-volatile memory of the present disclosure includes a memory cell array including one or more non-volatile memory cells each configured to accumulate charge at two portions of an charge accumulation layer, the two portions corresponding to a first bit and a second bit, an address decoder configured to select one of the memory cells from the memory cell array, a write driver configured to write data to the selected memory cell, a sense amplifier configured to read out data from the selected memory cell, a first buffer configured to supply write data to the write driver, a second buffer configured to store external data, a third data switch configured to select one of an output of the second buffer and an output of the sense amplifier, a fourth data switch configured to select one of an output of the buffer and the external data, and a data logic circuit configured to perform a calculation on an output of the third data switch and an output of the fourth data switch, and output a result of the calculation to the first buffer.

With this configuration, the inputting of external data to the second buffer and the inputting of the result of a calculation on the sense amplifier output and the external data to the first buffer can be performed in parallel. Moreover, it is not necessary to read out the external data again, resulting in a reduction in power consumption. The calculation on pieces of data stored in the buffer is hidden in the time that it takes to load the external data to the buffer, resulting in higher-speed program operation.

Moreover, the reading out of the first and second buffers and the inputting to the data logic circuit can be performed in parallel, whereby a data processing time is reduced, resulting in higher-speed program operation.

Another example non-volatile memory of the present disclosure includes a memory cell array including one or more non-volatile memory cells each configured to accumulate charge at two portions of an charge accumulation layer, the two portions corresponding to a first bit and a second bit, an address decoder configured to select one of the memory cells from the memory cell array, a write driver configured to write data to the selected memory cell, a sense amplifier configured to read out data from the selected memory cell, a first buffer and a second buffer, a fifth data switch configured to select and input one of an output of the first buffer and an output of the second buffer, as write data, to the write driver, a sixth data switch configured to select one of external data, an output of the sense amplifier, and the output of the first buffer, a seventh data switch configured to select one of the external data, the output of the sense amplifier, and the output of the second buffer, a data logic circuit configured to perform a calculation on an output of the sixth data switch and an output of the seventh data switch, and an eighth data switch configured to select and output one of an output of the data logic circuit and the external data to an input of the first buffer and an input of the second buffer.

With this configuration, the inputting of the external data to the first buffer and the inputting of the result of a calculation on the sense amplifier output and the external data to the second buffer can be performed in parallel, or the inputting of the external data to the second buffer and the inputting of the result of a calculation on the sense amplifier output and the external data to the first buffer, can be performed in parallel. In this case, it is not necessary to read out the external data again, resulting in a reduction in power consumption. The calculation on pieces of data stored in the buffer is hidden in the time that it takes to load the external data to the buffer, resulting in higher-speed program operation.

Moreover, the reading out of the first and second buffers and the inputting to the data logic circuit can be performed in parallel, whereby a data processing time is reduced, resulting in higher-speed program operation.

Moreover, the fifth data switch can be used to connect the first or second buffer to the write driver, whereby a more flexible algorithm can be supported.

As described above, the non-volatile memory of the present disclosure has the following six features.

1. Pulse application to a cell which has only a small contribution to an improvement in the threshold voltage of a memory cell at a low program level (i.e., small programmability) is reduced or prevented, whereby an excess program current is distributed to a cell which can be programmed, and therefore, current resources, such as a pump and the like, can be most efficiently utilized, thereby reducing the number of pulse counts.

2. By adding a minimum amount of hardware, the extraction of data depending on the opposite bit and the operation of loading external data can be simultaneously performed, thereby reducing the overhead of data processing of program operation;

3. A subset of external data depending on the opposite bit can be easily and quickly extracted by performing a simple logical operation (an AND operation, an OR operation, or the like) on the outputs of the buffer and the sense amplifier. An unprogrammed bit can be easily and quickly extracted by performing a simple logical operation (an AND operation, an OR operation, or the like) on outputs of buffers. As a result, the overhead of data processing of program operation can be reduced.

4. During application of a program pulse, the state of the opposite bit is fixed. Therefore, there are not variations in programmability which would be caused by changes in the state of the opposite bit, whereby variations in program distribution are reduced, resulting in an improvement in reliability.

5. The initial value of the pulse level can be determined, depending on the state of the opposite bit. Therefore, over-programming can be reduced or prevented, whereby a sharp shape of the threshold voltage distribution can be maintained, resulting in an improvement in the reliability of the non-volatile memory.

6. The aforementioned functions can be achieved by using a single write driver and a single power supply, resulting in a minimum circuit size.

### BRIEF DESCRIPTION OF THE DRAWINGS

FIG. 1 is a block diagram of a non-volatile memory according to an embodiment of the present disclosure.

FIG. 2 is a block diagram of a shared-memory-with-register type buffer/logic block according to a first variation of the embodiment.

FIG. 3 is a block diagram showing an asymmetric-dual-memory type buffer/logic block according to a second variation of the embodiment.

FIG. 4 is a block diagram of a symmetric-dual-memory type buffer/logic block according to a third variation of the embodiment.

FIG. 5 is a diagram showing a relationship between buffer addresses and a memory array in the embodiment.

FIG. 6 is a flowchart showing program operation of the embodiment.

FIG. 7 is a flowchart showing a detailed flow of an external data select step in the flowchart of the program operation.

FIG. 8A is a diagram showing a truth table of a data logic circuit in the external data select step in the embodiment, which indicates a logic of extraction of program data whose opposite bit is in the programmed state.

FIG. 8B is a diagram showing a truth table in which the truth values of the truth table of FIG. 8A are reversed.

FIG. 8C is a diagram showing a truth table indicating a logic of extraction of program data whose opposite bit is in the erased state.

FIG. 8D is a diagram showing a truth table in which the truth values of the truth table of FIG. 8C are reversed.

FIG. 9 is a flowchart showing details of a program step in the flowchart of the program operation.

FIG. 10A is a diagram showing a truth table for the data logic circuit during verify operation in the embodiment.

FIG. 10B is a diagram showing a truth table in which the truth values of the truth table of FIG. 10A are reversed.

FIG. 11 is a flowchart showing details of an unprogrammed data extraction step in the flowchart of the program operation.

FIG. 12A is a diagram showing a truth table for the data logic circuit during unprogrammed data extraction operation in the embodiment.

FIG. 12B is a diagram showing a truth table in which the truth values of the truth table of FIG. 12A are reversed.

FIG. 13 is a flowchart showing details of a program step in the flowchart of the program operation.

FIG. 14 is a flowchart showing program operation additionally including a program verify step in the embodiment.

FIG. 15 is a flowchart showing details of the program verify step in the flowchart of the program operation additionally including the program verify step.

FIG. 16 is a diagram for describing a relationship between program pulse levels and buffer data in the embodiment.

FIG. 17A is a cross-sectional view of a conventional non-volatile memory cell.

FIG. 17B is a top view of the conventional non-volatile memory cell.

FIG. 17C is a diagram showing an equivalent circuit of the conventional non-volatile memory cell.

FIG. 18A is a diagram showing characteristics indicating a relationship between program pulse levels and memory cell threshold voltages of a conventional memory cell.

FIG. 18B is a diagram for describing an algorithm where a program pulse start voltage is set to have a low initial value.

FIG. 18C is a diagram for describing an algorithm where a program pulse start voltage is set to have a high initial value.

### DETAILED DESCRIPTION

An embodiment of the present disclosure will be described hereinafter with reference to the accompanying drawings. Note that the embodiment is only for illustrative purposes, and the scope and spirit of the present disclosure are not limited to the embodiment.

### Embodiment

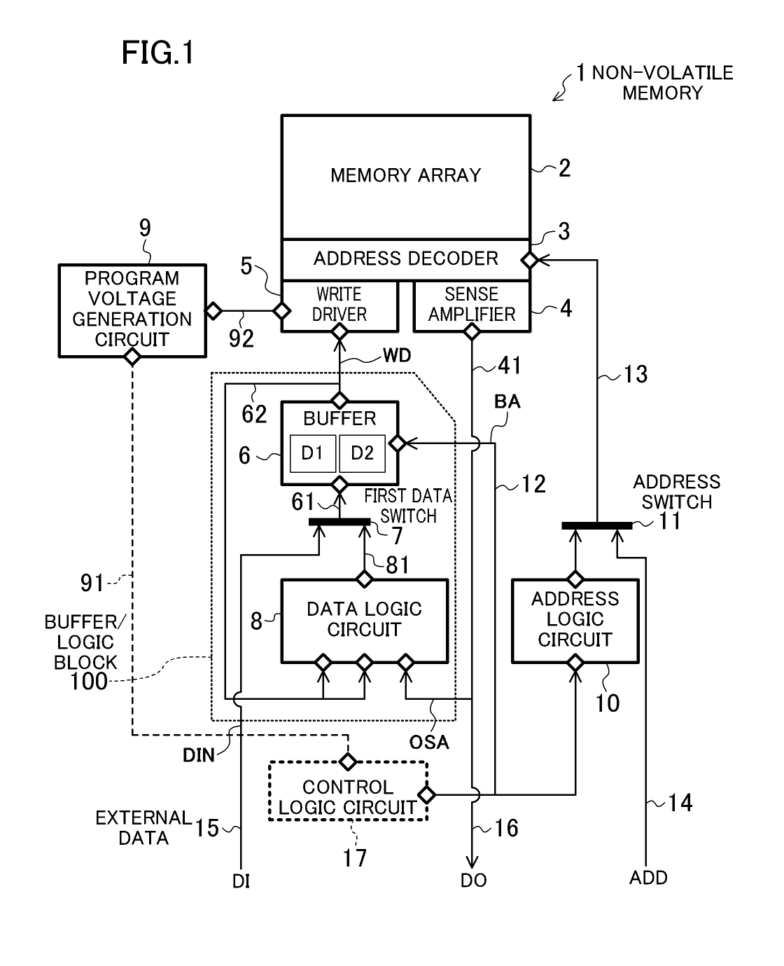

FIG. 1 is a block diagram of a non-volatile memory according to the embodiment of the present disclosure.

In FIG. 1, the non-volatile memory 1 includes a memory cell array 2, an address decoder 3 which selects a predetermined memory cell, a sense amplifier 4 which reads out data stored in a memory cell, a write driver 5 which applies a program pulse to a memory cell, a buffer 6 which supplies program data to the write driver 5, a data logic circuit 8 which performs a calculation on an output of the buffer 6 and an output of the sense amplifier 4, a first data switch 7 which inputs to the buffer 6 one of an output 81 of the data logic circuit 8 and external data, a program voltage generation circuit 9 which generates an output voltage of the write driver 5, an address logic circuit 10 which generates an array address 13 from an internal address 12, an address switch 11 which selects as an array address 13 one of an externally input address 14 and an output of the address logic circuit 10, and a control logic circuit 17 which controls these components.

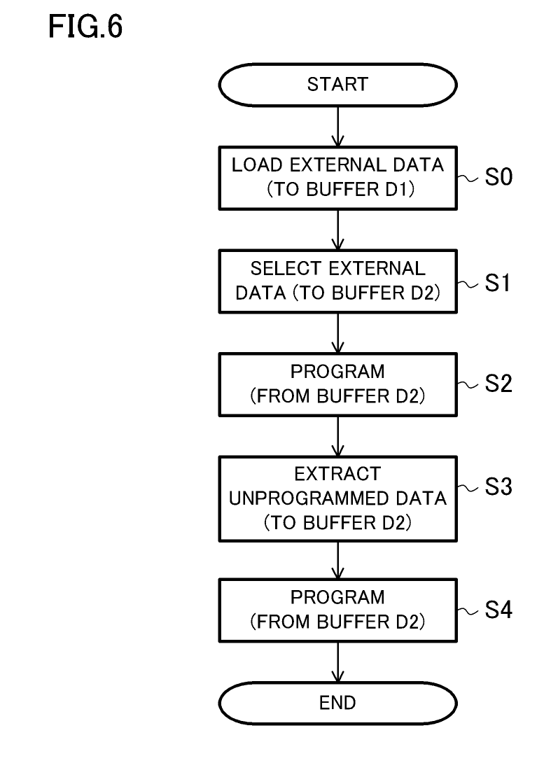

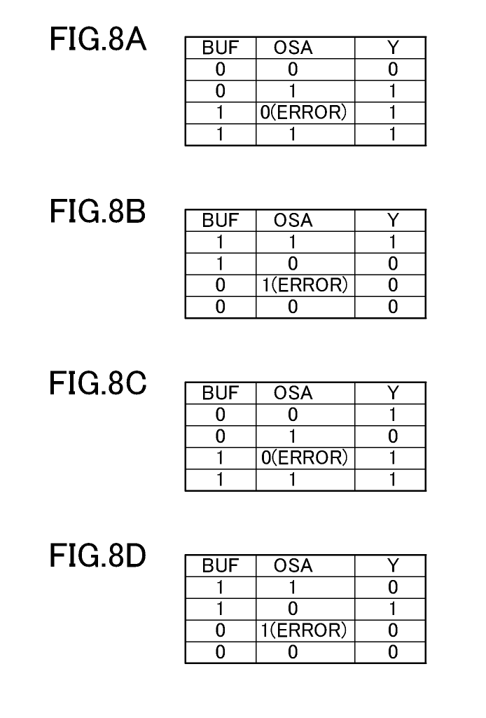

Program operation of this non-volatile memory will be described hereinafter with reference to flowcharts shown in FIGS. 6, 7, 9, 11, 13, 14, and 15, and truth tables used by the data logic circuit 8 shown in FIGS. 8A-8D, 10A and 10B, and 12A and 12B.

FIG. 6 is a flowchart showing the overall program operation of this embodiment. In FIG. 6, the program operation is achieved by successively performing the following steps: (S0) storing external data to be programmed into a data area D1 of the buffer 6 (referred to as a buffer D1); (S1) extracting a bit whose opposite bit is in the programmed state from data stored in the buffer D1, and storing the bit into a data area D2 of the buffer 6 (referred to as a buffer D2); (S2) programming a memory cell based on data of the buffer D2; (S3) extracting data which has not yet been programmed (referred to as unprogrammed data) from external data, and storing the unprogrammed data into the buffer D2; and (S4) programming a memory cell based on data of the buffer D2. The step S1 and thereafter will be described in greater detail hereinafter.

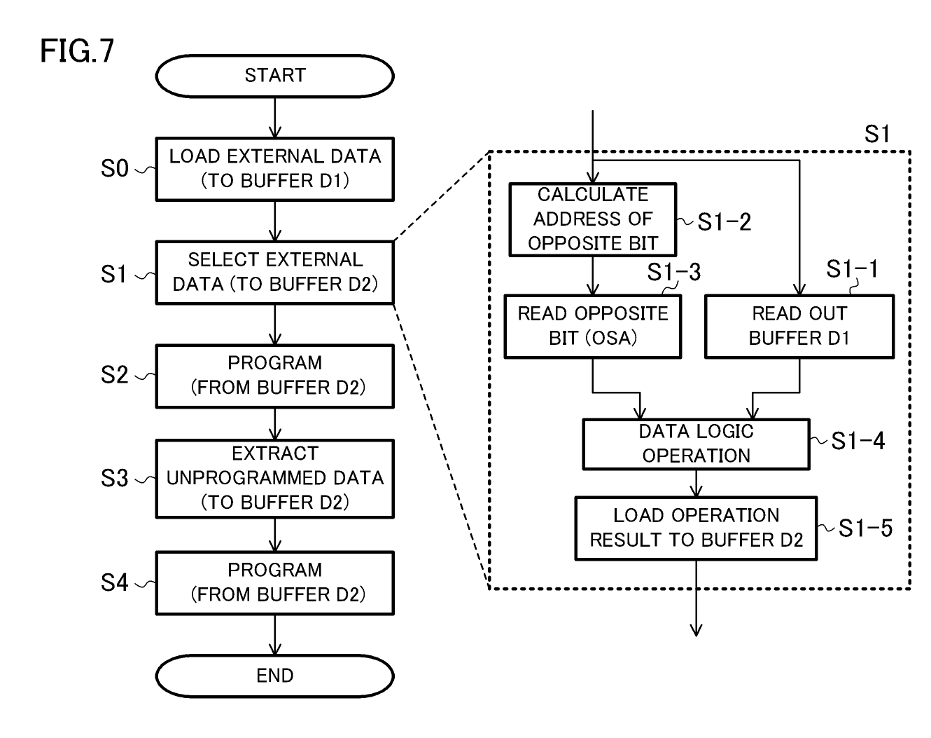

FIG. 7 shows a detailed flow of external data select operation of step S1. The flow will be described hereinafter with reference to the block diagram of FIG. 1 as well.

(S1-1: Reading Of Buffer D1)

Data is read out from the buffer D1 based on the internal address 12 generated by an address generator (not shown) provided in the control logic circuit 17.

(S1-2 and S1-3: Reading of Opposite Bit)

An address of an opposite bit corresponding to an address indicated by an internal address (BA) 12 is calculated by the address logic circuit 10. The result of the calculation is input via the address switch 11 to the address decoder 3. A state of the opposite bit is read out by a sense amplifier output (OSA) 41.

The address switch 11 is configured to input the externally input address 14 to the address decoder 3 during normal read operation.

(S1-4: Logical Operation of Data Logic Circuit)

Read data (BUF) of the buffer 6 and read data (OSA) of the sense amplifier 4 are input to the data logic circuit 8, which then performs a logical operation on both pieces of read data and outputs the result of the logical operation (Y). Truth tables for the logical operation are shown in FIGS. 8A-8D.

FIGS. 8A and 8B show the logic of extraction of program data where the opposite bit is in the programmed state. Two tables can be prepared which have different sets of truth values. FIG. 8A shows a truth table where application of pulses and the programmed state are represented by “0,” and application of no pulses and the erased state are represented by “1.” FIG. 8B shows a truth table where the truth values of FIG. 8A are reversed.

FIGS. 8C and 8D show the logic of extraction of program data when the opposite bit is in the erased state. Similarly, two tables can be prepared which have different sets of truth values. FIG. 8C shows a truth table where application of pulses and the programmed state are represented by “0,” and application of no pulses and the erased state are represented by “1.” FIG. 8D shows a truth table where the truth values of FIG. 8C are reversed.

As an example, it is assumed that a logical operation is performed in accordance with the truth table of FIG. 8A.

(S1-5: Buffer Output as Result of Calculation)

An output of the data logic circuit 8 is written to the buffer D2. A subset (inclusion relation) of data stored in the buffer D1 is stored in the buffer D2. The subset contains only program data where the opposite bit is in the programmed state.

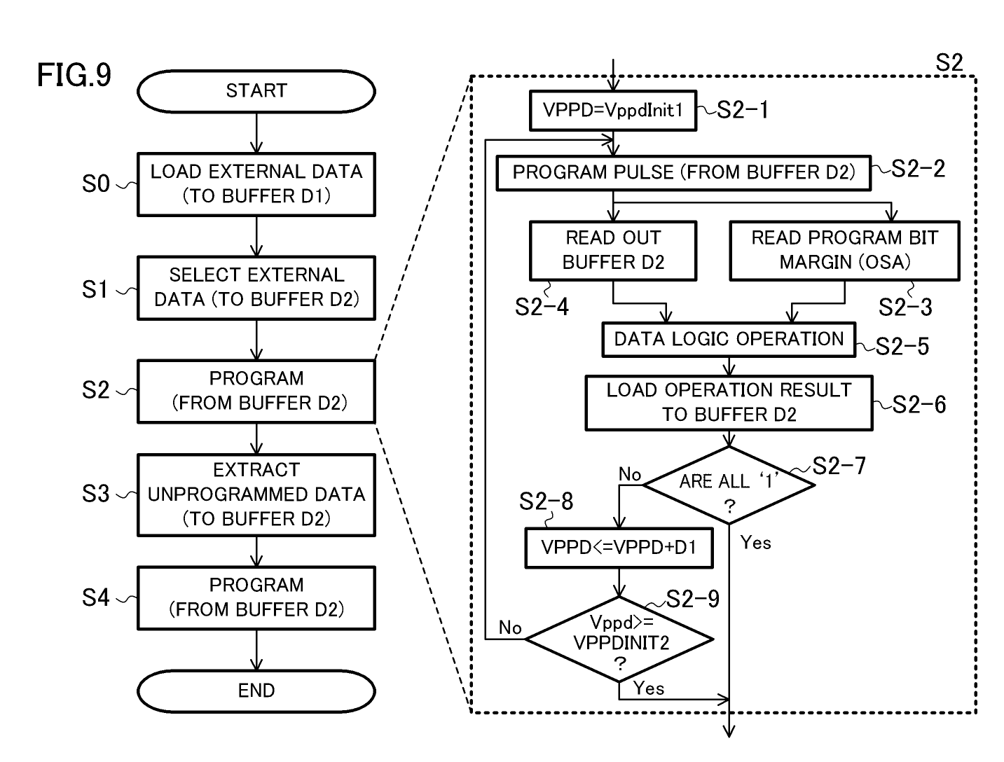

FIG. 9 shows a detailed flow of first program operation of step S2.

(S2-1: Initialization of Program Level)

The control logic circuit 17 sets a voltage Vppdinit1 as an initial value into the program voltage generation circuit 9 so that the write driver 5 gets ready to output the voltage Vppdinit1. The voltage Vppdinit1 has a level optimum to program data stored in the buffer D2. The state of the opposite bit of program data can be fixed. Specifically, it is no longer necessary to consider a difference in program characteristic between data states of the opposite bit, and therefore, the optimum level can be easily set. The voltage Vppdinit1 can be set and adapted to variations during manufacture by a learning technique, such as test write or the like.

(S2-2: Application of Program Pulse)

Data stored in the buffer D2 is transferred to the write driver 5, which then applies a program pulse to a memory cell specified by the address decoder 3. In this case, the address logic circuit 10 is in a pass-through mode, so that the same address as the internal address 12 is input to the address decoder 3.

The write driver 5 can apply program pulses in a time-division manner so that the number of simultaneously applied program pulses matches a maximum of driving capability of the internal power supply.

(S2-3 to S2-9: Program Verify)

Data is read out from the sense amplifier 4 and the buffer D2 based on an address indicated by the internal address (steps S2-3 and S2-4). In this case, as in the case of pulse application, the address logic circuit 10 is in a pass-through mode, so that the same address as the internal address 12 is input to the address decoder 3.

The data logic circuit 8 performs a logical operation on the read data (BUF) of the buffer 6 and the read data (OSA) of the sense amplifier 4, and outputs the result of the logical operation (Y) (step S2-5).

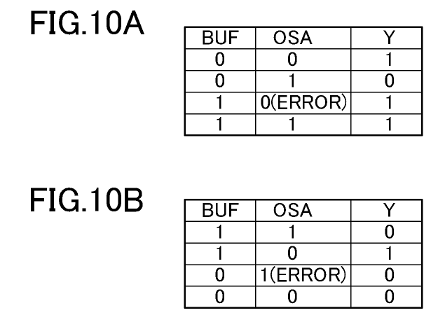

Here, truth tables for a logical operation in program verify operation are shown in FIGS. 10A and 10B. Here, also, two tables can be prepared which have different sets of truth values. FIG. 10A shows a truth table where application of pulses and the programmed state are represented by “0,” and application of no pulses and the erased state are represented by “1.” FIG. 10B shows a truth table where the truth values of FIG. 10A are reversed.

The logical operation output (Y) is written back to the buffer D2 (steps S2-6), and a program pulse end condition is checked by the control logic circuit 17. In the example of FIG. 10A, the control logic circuit 17, when all pieces of data stored in the buffer D2 are “1,” determines that the program operation for the data stored in the buffer D2 has been completed (no remaining program bits). In this case, thereafter, control proceeds to the next step (step S2-7).

The control logic circuit 17, when data “0” remains in the buffer D2, increments the output voltage VPPD of the program voltage generation circuit 9 by a step D1 (step S2-8), and in addition, when the output voltage VPPD is still lower than a voltage Vppdinit2, returns to the program pulse application step S2-2. When the voltage VPPD is higher than or equal to the voltage Vppdinit2, control proceeds to the next step while a program bit is left in the buffer D2 (step S2-9).

The voltage Vppdinit2 is an initial value of a pulse which is applied in step S4. Here, in the buffer D2, depending on the presence or absence of a remaining bit (unprogrammed bit) after the completion of the first program operation, opposite bits having the programmed data state and the erased data state may coexist in the subsequent program operation for the remaining bit, and the remaining bit may be over-programmed.

To reduce or avoid this, preferably, the voltage Vppdinit2 may be set to be slightly lower than a value which has been obtained by performing test write operation with respect to a memory cell having a predetermined state, such as a state in which the opposite bit is in the erased state, or the like, or alternatively, the step D1 may be decreased during a period of time that the number of pulses has an initial value. As a result, it is possible to reduce or overcome the problem that the remaining bit of the buffer D2 is over-programmed and therefore a broad threshold voltage distribution occurs.

In this embodiment, the voltage VPPD is incremented so that the convergence performance of the program distribution is improved. Alternatively, the voltage VPPD may be maintained at the previous value or decremented by partial pulse application. The step or the program pulse width, or the word line voltage during programming of a memory cell, may be preferably variable.

For example, the threshold voltage of a MONOS memory cell can be set to a high level by increasing the word line voltage in a stepwise manner or expanding the program pulse, as in the case of the step algorithm. The program speed is, however, sensitive to the drain voltage, and less sensitive to the pulse width or the word line voltage. In view of this property, the threshold voltages of a multi-level memory are preferably precisely controlled, depending on the pulse width or the word line voltage.

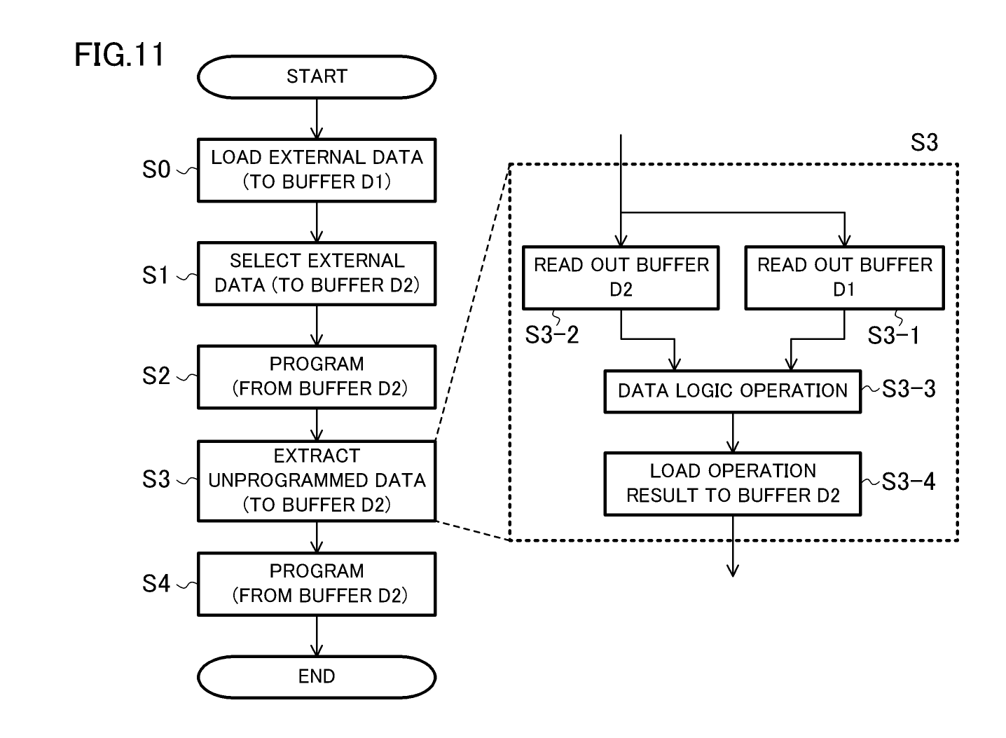

FIG. 11 shows a detailed flow of the operation of step S3.

(S3: Extraction of Unprogrammed Data)

The control logic circuit 17 reads out the buffers D1 and D2 sequentially or in parallel from the buffer 6 (steps S3-1 and S3-2), and the data logic circuit 8 calculates and extracts an unprogrammed bit (step S3-3).

The control logic circuit 17 selects whether to read out the buffers D1 and D2 sequentially or in parallel from the buffer 6, depending on a trade-off between the program speed and the area, for example.

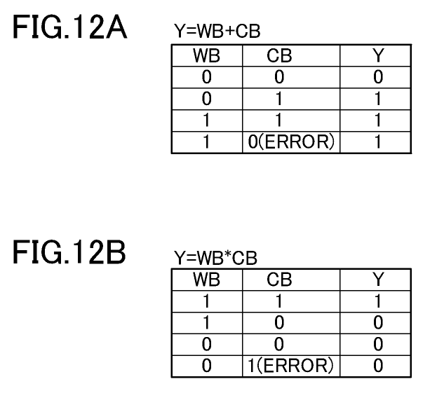

Truth tables of a logical operation for extraction of unprogrammed data are shown in FIGS. 12A and 12B. In FIGS. 12A and 12B, WB and CB correspond to the buffers D1 and D2, respectively. Similarly, two tables can be prepared which have different sets of truth values. FIG. 12A shows a truth table where application of pulses and the programmed state are represented by “0,” application of no pulses and the erased state are represented by “1,” and the logical operation may be an OR operation. FIG. 12B shows a truth table where the truth values of FIG. 12A are reversed, and the logical operation is an AND operation.

The control logic circuit 17 writes the logical operation output (Y) back to the buffer D2 (step S3-4). Thereafter, control proceeds to step S4.

As an example, it is assumed that a logical operation is performed in accordance with the truth table of FIG. 8A. In this case, program data where only an opposite bit(s) in the erased state is present, or program data where both an opposite bit(s) in the erased state and an opposite bit(s) in the programmed state are present, is stored in the buffer D2. Moreover, a program pulse has already been applied to a bit whose opposite bit is in the programmed state in step S2, and therefore, the subsequent pulse application needs to be performed with caution.

Although program operation can be similarly performed no matter whether the logical operation output is written back to the buffer D1 or the buffer D2, in this embodiment the logical operation output is deliberately written back to the buffer D2. In this case, even after application of a program pulse, external data can be stored in the buffer D1, and therefore, final program verify operation can be performed in the non-volatile memory, resulting in highly reliable program operation. This requires program verify operation between a host system and the non-volatile memory, resulting in overhead of the system performance.

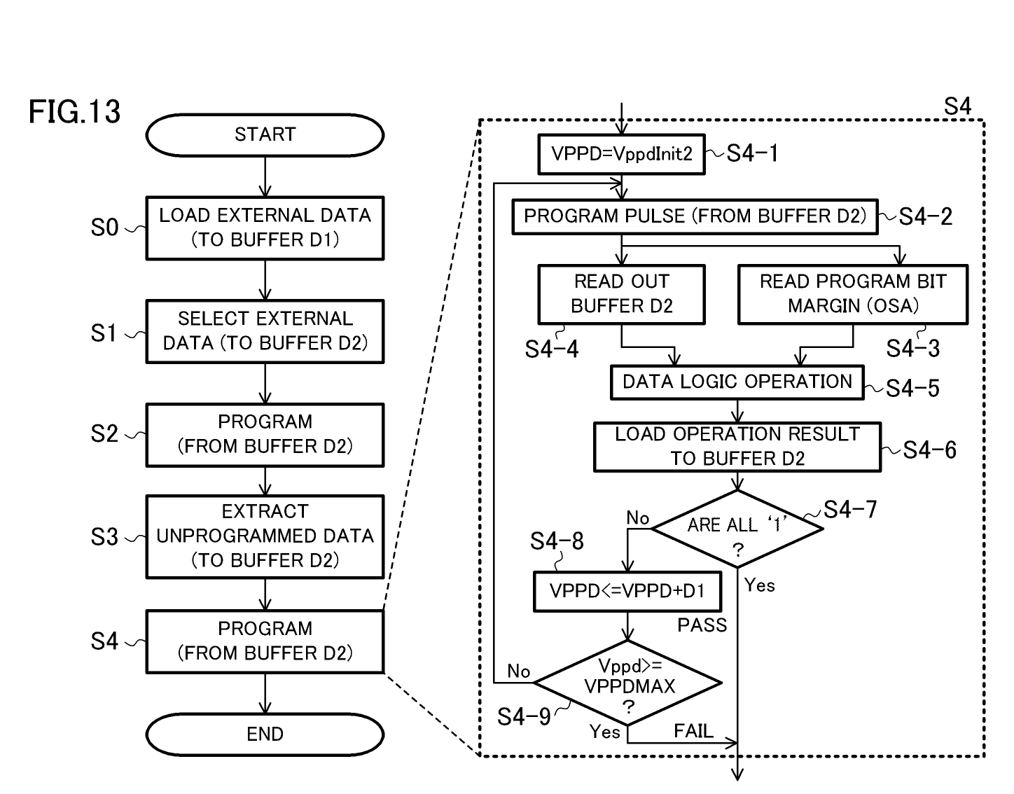

FIG. 13 shows a detailed flow of the operation of step S4. Step S4 is similar to step S2, and is a final program step.

(S4-1: Initialization of Program Level)

The control logic circuit 17 sets the voltage Vppdinit2 as an initial value to the program voltage generation circuit 9 so that the write driver 5 gets ready to output the voltage Vppdinit2.

(S4-2: Application of Program Pulse)

As in step 2, data stored in the buffer D2 is transferred to the write driver 5, which then applies a program pulse to a memory cell specified by the address decoder 3. In this case, the address logic circuit 10 is in a pass-through mode, so that the same address as the internal address 12 is input to the address decoder 3.

(S4-3 to S4-9: Program Verify)

Data is read out from the sense amplifier 4 and the buffer D2 based on an address indicated by the internal address 12 (steps S4-3 and S4-4). In this case, as in the case of pulse application, the address logic circuit 10 is in a pass-through mode, so that the same address as the internal address 12 is input to the address decoder 3.

The data logic circuit 8 performs a logical operation on the read data (BUF) of the buffer 6 and the read data (OSA) of the sense amplifier 4, and outputs the result of the logical operation (Y) (step S4-5).

A truth table for a logical operation in program verify operation is similar to that which is used in step S2. The logical operation output (Y) is written back to the buffer D2 (step S4-6), and the program pulse end condition is checked by the control logic circuit 17 (step S4-7).

It is assumed that the logical operation truth table of FIG. 10A is used. The control logic circuit 17, when all pieces of data stored in the buffer D2 are “1,” determines that the program operation for the data stored in the buffer D2 has been completed. The program operation is ended in the pass state. The control logic circuit 17, when data “0” remains in the buffer D2, increments the output voltage VPPD of the program voltage generation circuit 9 by the step D1 (steps S4-7 and S4-8), and in addition, when the output voltage VPPD is lower than a maximum voltage VPPDMAX, returns to the program pulse application step S4-2. When the voltage VPPD is higher than or equal to the voltage VPPDMAX, the program operation fails and ends (step S4-9).

Next, a flow of a program algorithm having improved reliability will be described.

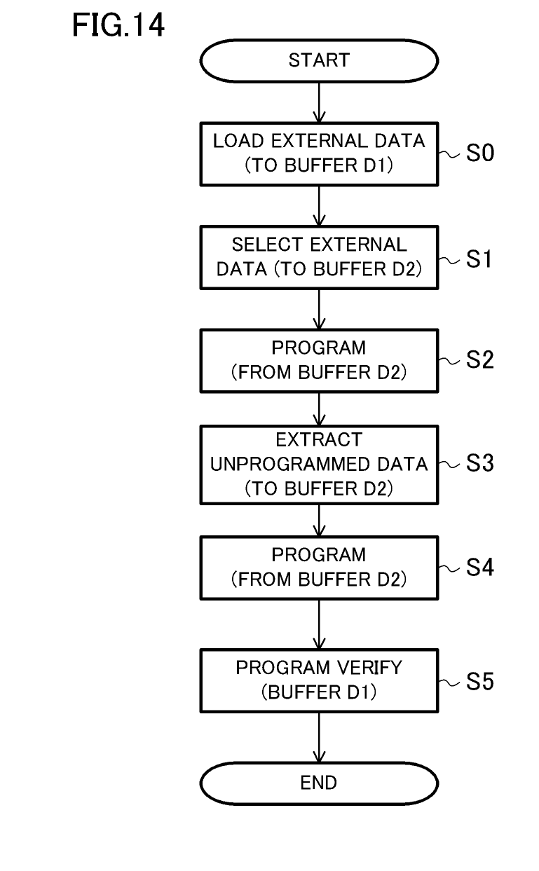

FIG. 14 shows a flow of program operation additionally including a program verify step. In FIG. 14, the program verify step S5 is added after the final program step S4 of FIG. 6.

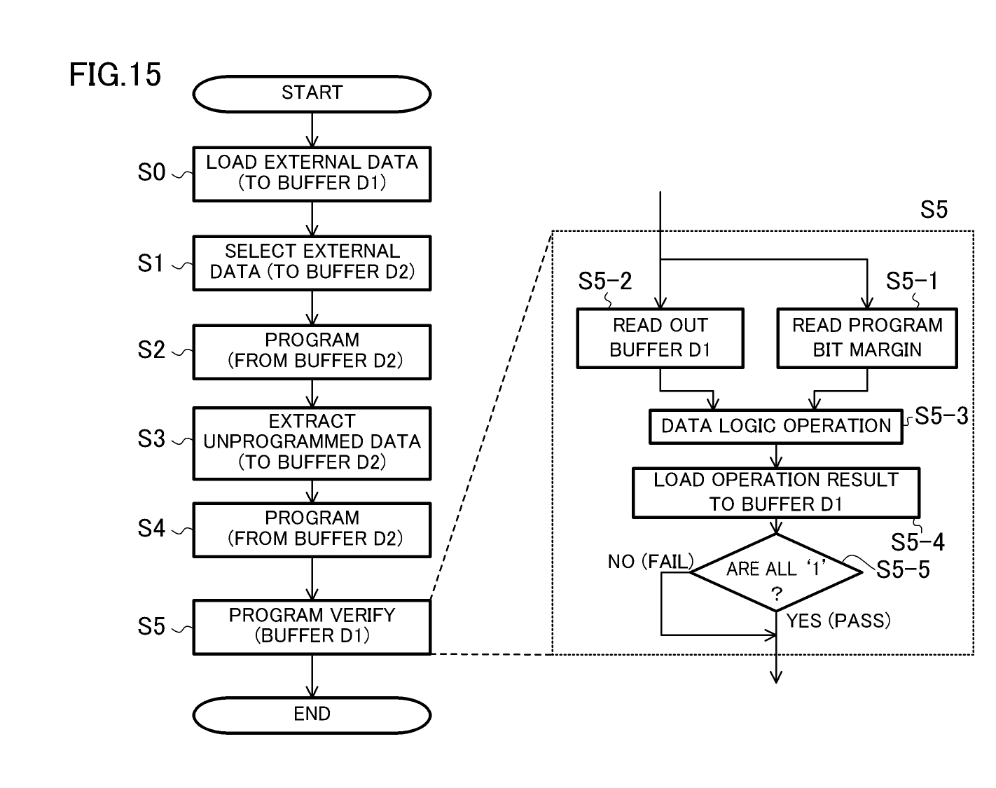

FIG. 15 shows a detailed flow of the operation of step S5.

Data is read out from the sense amplifier 4 and the buffer D1 based on an address indicated by the internal address 12 of the control logic circuit 17 (steps S5-1 and S5-2). In this case, as in the case of pulse application, the address logic circuit 10 is in a pass-through mode, so that the same address as the internal address 12 is input to the address decoder 3.

The data logic circuit 8 performs a logical operation on the read data (BUF) of the buffer 6 and the read data (OSA) of the sense amplifier 4, and outputs the result of the logical operation (Y) (step S5-3).

Truth tables for the logical operation in the program verify operation are expressed by FIGS. 10A and 10B as in the case of the aforementioned program verify operation.

The logical operation output (Y) is written back to the buffer D1 (step S5-4), and the program pulse end condition is checked by the control logic circuit 17 (step S5-5). For example, in the case of the truth table of FIG. 10A, if all contents of the buffer D1 are “1,” the external data equals the result of the program operation (PASS).

Thus, by using the buffer D1 for the final program verify operation, the memory resources of the buffer 6 can be efficiently used, whereby highly reliable write operation can be achieved.

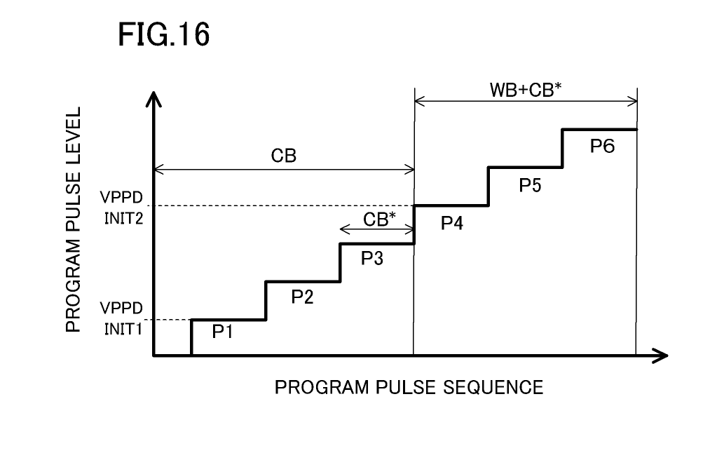

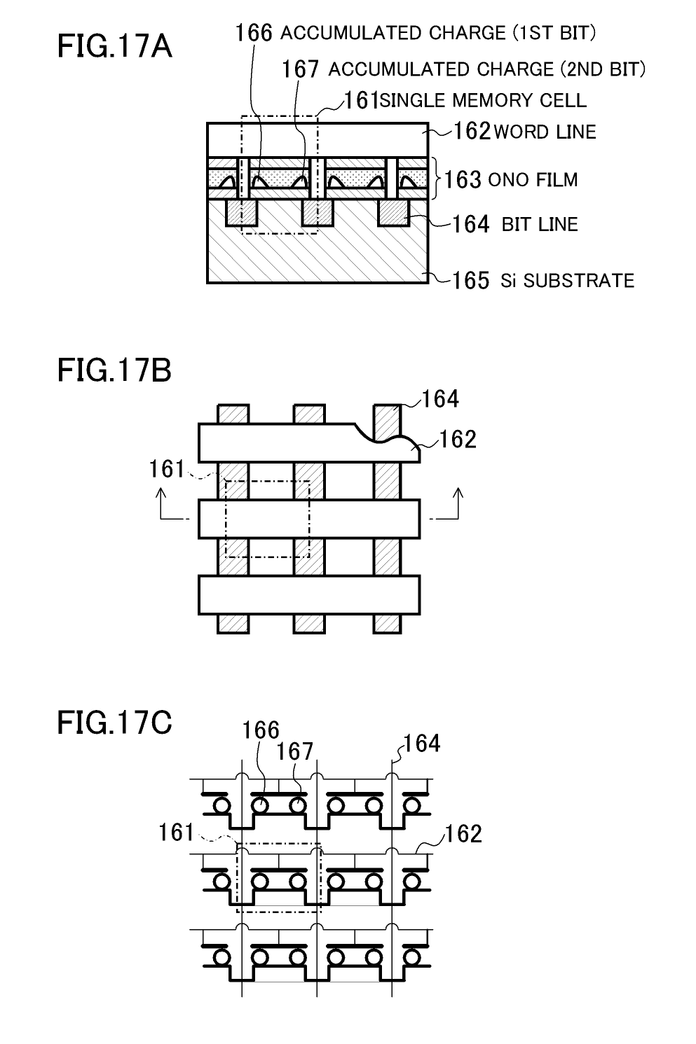

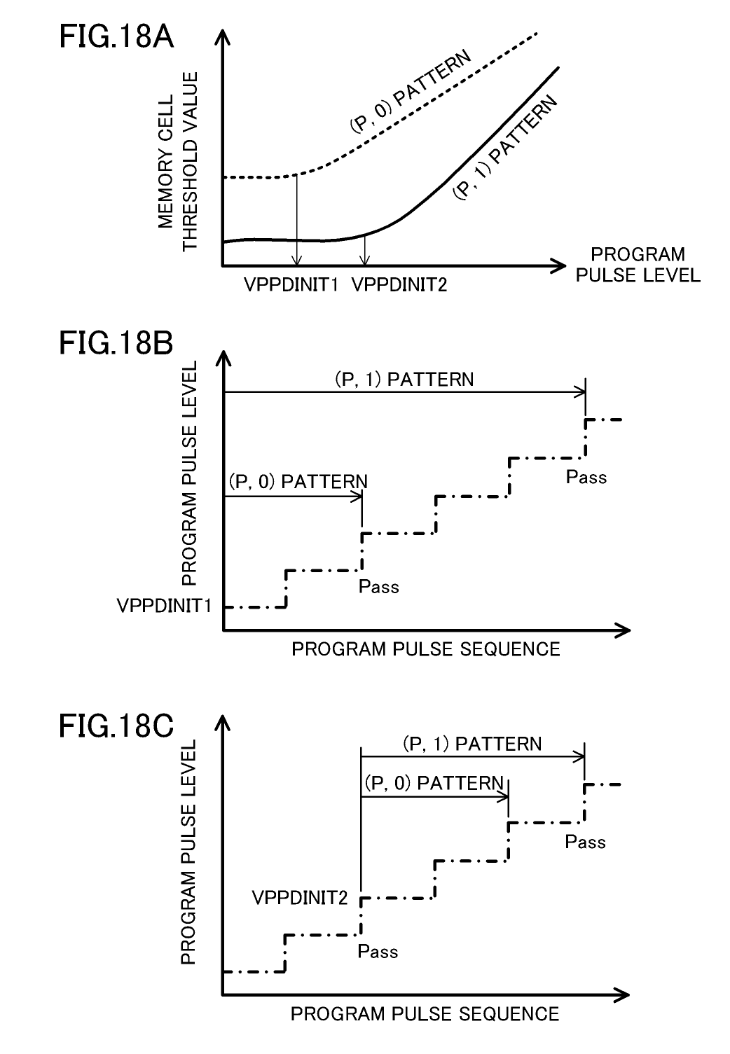

FIG. 16 shows a graph for describing a relationship between program pulse levels and buffer data, where the voltage VPPD is monotonically increased in a stepwise manner in the aforementioned program operation. In the graph, the horizontal axis indicates program pulses P1, P2, . . . , and P6 applied sequentially in time, and the vertical axis indicates the levels VPPD of program pulses.

When the program pulses P1, P2, and P3 are applied, a subset (CB) of the external data WB is programmed as buffer data. CB is a subset data where the opposite bit is in the programmed state. The initial starting program pulse P1 has the voltage VPPINIT1. The program data of CB decreases as the pulses are sequentially applied. After the application of the pulse P3, the value of CB is CB*.

After the pulse P3, the pulse voltage is reset to VPPDINIT2, i.e., the voltage of the pulse P4 is VPPDINIT2. Also, the data of the buffer 6 is changed to data obtained by an OR operation on the external data WB and CB*.

A state in which a program pulse is applied is indicated by a logical value “0,” and a state in which a program pulse is not applied is indicated by a logical value “1.” The external program WB+CB* indicates a remaining program bit(s).

The program pulse P4 and thereafter are sequentially applied based on the data WB+CB*. If all bits of the data WB+CB* have the logical value “1,” the program operation is ended.

With the program algorithm, a remaining program bit(s) can be extracted using a considerably easy technique. The pulses P1-P3 are applied to only a memory cell(s) in which an opposite bit, which can be programmed with a low voltage, is programmed. Therefore, although a program current having a small programmability is consumed, a program pulse is not applied to a bit whose opposite bit is in the erased state and have small variations in the threshold voltage. Thus, the output current of the internal boost power supply is efficiently used.

If an algorithm, such as bit search or the like, is employed in which, compared to a conventional technique in which a pulse is not applied to a limited subset data, a program current during the application of the pulses P1, P2, and P3 is not wasted and can be applied to more program bits, higher-speed operation can be achieved. The bit search is a technique of collecting and arranging as large a number of program bits as possible in parallel, and simultaneously programming the program bits. Therefore, the number of program bits can be invariably maintained close to the tolerable value of hardware, resulting in a highest current efficiency.

Moreover, the initial value of the program voltage can be set, depending on the state of the opposite bit, whereby the spread of the threshold voltage distribution after programming can be reduced or prevented, resulting in an improvement in the reliability of the cell.

While, in the above description, it is assumed that higher programmability is obtained when the opposite bit is in the programmed state, there is a cell technology in which higher programmability is obtained when the opposite bit is in the erased state. In this case, needless to say, if CB is considered as a subset data where the opposite bit is in the erased state, a similar advantage can be obtained.

Next, a variation of this embodiment will be described below where a buffer/logic block 100 of FIG. 1 is modified.

(First Variation)

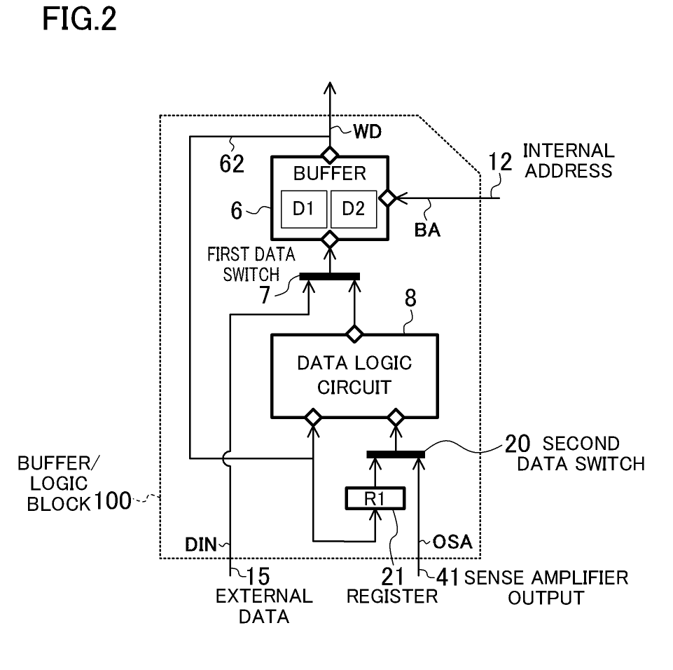

FIG. 2 is a block diagram of a shared-memory-with-register type buffer/logic block 100 according to the embodiment of the present disclosure.

The buffer/logic block 100 of FIG. 2 is mainly different from that of FIG. 1 in that the buffer/logic block 100 further includes a second data switch 20 and a register 21. An output 62 of the buffer 6 is input directly to an input of the data logic circuit 8, and is also input to the register 21. One of an output of the register 21 and the output 41 of the sense amplifier 4 is selected by the second data switch 20 and then input to the data logic circuit 8. With this configuration, calculation is performed on pieces of data in the buffer 6 and on data of the buffer 6 and the output 41 of the sense amplifier 4. Note that even if the register 21 may be provided at an input on the left-hand side of the data logic circuit 8, similar connection may be achieved. In this case, a data switch which bypasses the register 21 is additionally required, resulting in an increase in a circuit size.

The aforementioned functional advantages are also achieved. By providing the register 21, a single memory can be used to construct the buffer 6, resulting in an area reduction.

(Second Variation)

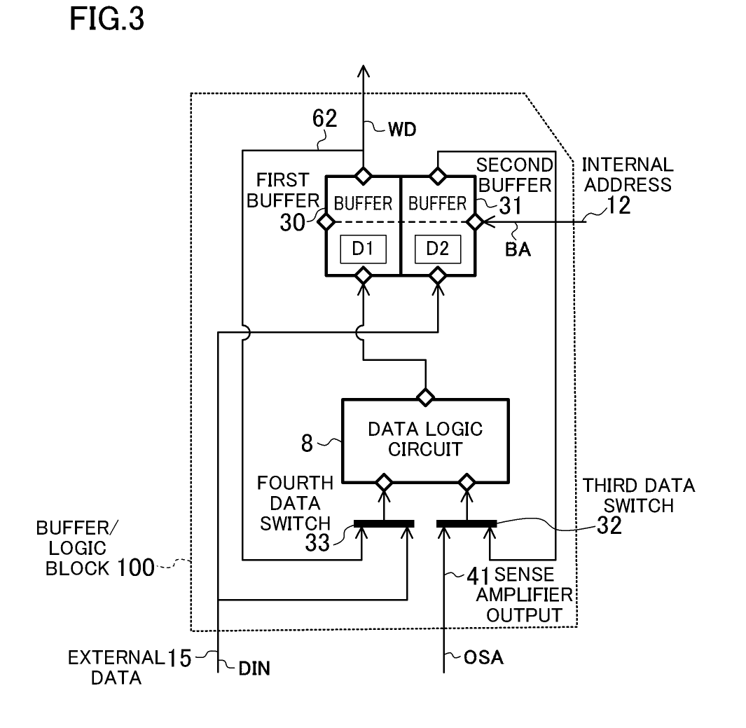

FIG. 3 is a block diagram showing an asymmetric-dual-memory type buffer/logic block 100 according to the embodiment of the present disclosure.

The buffer/logic block 100 of FIG. 3 is different from that of FIG. 2 in that the buffer 6 includes two separate memories, i.e., a first buffer 30 and a second buffer 31, and a path of external data 15 to the data logic circuit 8 is newly provided. The first and second buffers 30 and 31 can store the aforementioned buffers D1 and D2, respectively.

In FIG. 3, the second buffer 31 is dedicated to inputting the external data 15. One of an output of the second buffer 31 and the sense amplifier output 41 is selected by a third data switch 32, and then input to the data logic circuit 8. Only the first buffer 30 is connected to the output 62 of the buffer 6 to drive the write driver 5. One of the buffer output 62 and the external data 15 is selected by a fourth data switch 33, and then input to the data logic circuit 8.

With this configuration, the operation of inputting the external data 15 to the second buffer 31, and the operation of performing a logical operation on the external data 15 and the output 41 of the sense amplifier 4 and inputting the result of the logical operation to the first buffer 30 can be performed in parallel, resulting in a reduction in the overhead of program operation.

Moreover, data from the first buffer 30 and data from the second buffer 31 can be read out and calculated in parallel, resulting in a reduction in the overhead of program operation.

(Third Variation)

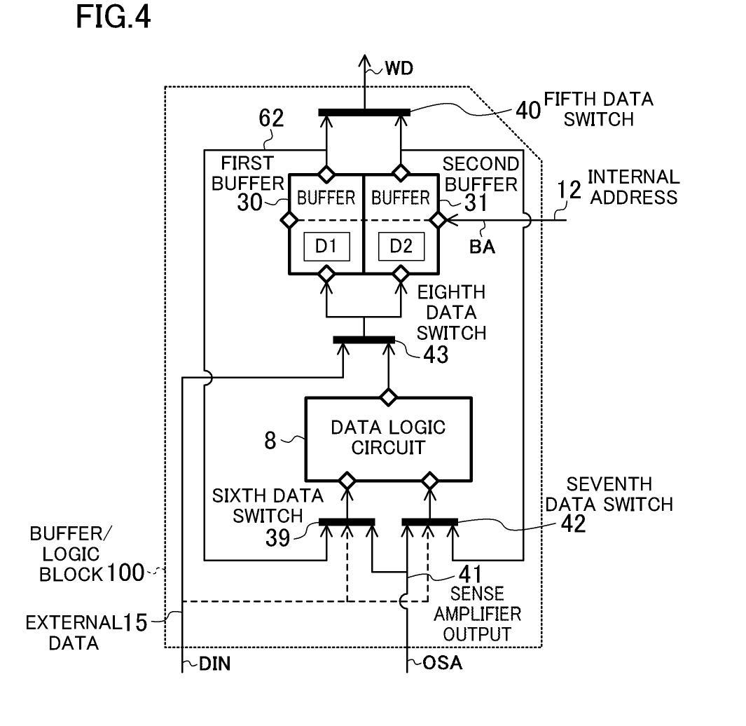

FIG. 4 is a block diagram showing a symmetric-dual-memory type buffer/logic block 100 according to the embodiment of the present disclosure.

The buffer/logic block 100 of FIG. 4 is different from that of FIG. 3 in that the buffer memories are symmetric.

A fifth data switch 40 selects one of the first and second buffers 30 and 31 to drive the write driver 5. Outputs of the first and second buffers 30 and 31 are connected to a sixth data switch 39 and a seventh data switch 42, respectively. The sixth and seventh data switches 39 and 42 are each a three-input data switch which selects and inputs one of the buffer output, the external data 15, and the sense amplifier output 41 to the data logic circuit 8.

The external data 15 can be input to any of the buffers 30 and 31. The write driver 5 can be driven using any of the buffers 30 and 31.

The buffer memories can be symmetrically interchanged. Therefore, in addition to the advantage of FIG. 3, the buffer memories can be more flexibly adapted to algorithms rather than being fixed to a single way of using the buffer memories.

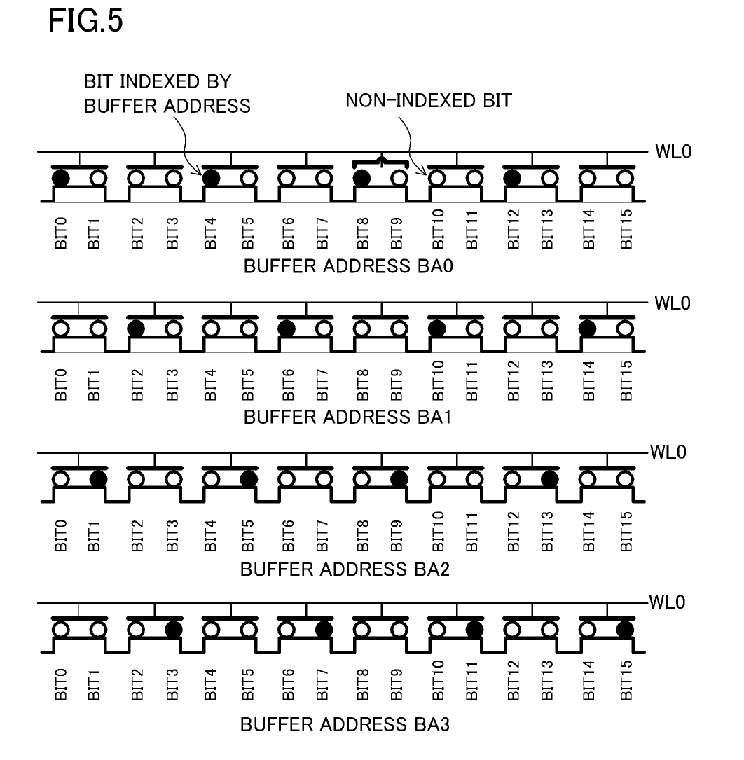

FIG. 5 shows an example relationship between buffer addresses and a memory array in the embodiment of the present disclosure.

FIG. 5 shows physical bit positions (indicated by closed circles) indexed by buffers in buffer addresses BA0-BA3 on a word line WL0. A buffer is a program data packet including one or more pieces of program data. In this embodiment, a physical bit indexed by a buffer is mapped so that an opposite bit is excluded.

For example, at the buffer address BA0, physical bits 0, 4, 8, and 12 are indexed, each of which is not an opposite bit to any of the others. This holds true for the buffer addresses BA1, BA2, and BA3.

The state of an opposite bit is fixed during application of a program pulse. As a result, there are not variations in programmability which would be caused by changes in the state of the opposite bit, whereby variations in program distribution can be reduced or prevented, resulting in an improvement in reliability.

As described above, the non-volatile memory of the present disclosure is a multi-bit memory, such as an NROM flash memory or the like, in which the reduction in program speed and the expansion of a distribution of program threshold voltages due to a program characteristic which varies depending on the state of an opposite bit, can be reduced or prevented, and therefore, is considerably useful for non-volatile memories which provide lower-cost, higher-speed, and more highly reliable program operation.

1. A non-volatile memory comprising:
a memory cell array including one or more non-volatile memory cells each including bits which accumulate charge in different areas of an charge accumulation layer;
an address decoder configured to select one of the memory cells from the memory cell array;
a write driver configured to write data to the selected memory cell;
a sense amplifier configured to read out data from the selected memory cell;
a buffer configured to supply write data to the write driver; and
a data logic circuit configured to perform a calculation on different pieces of data stored in the buffer, and a calculation on a piece of data stored in the buffer and an output of the sense amplifier,
wherein
at least one of an output of the data logic circuit and external data is input to the buffer.

2. The non-volatile memory of claim 1, further comprising:
a first data switch configured to select and input one of the output of the data logic circuit and the external data to the buffer.

3. The non-volatile memory of claim 1, further comprising:
a fourth data switch configured to select and input one of the output of the buffer and the external data to the data logic circuit.

4. The non-volatile memory of claim 1, further comprising:
a register configured to hold the output of the buffer,
wherein
the data logic circuit further performs a calculation on the output of the buffer and an output of the register.

5. The non-volatile memory of claim 1, wherein
the non-volatile memory cell accumulates charge at two portions of the charge accumulation layer, the two portions corresponding to a first bit and a second bit, and
data stored in the buffer at a time corresponds to one of the first and second bits.

6. The non-volatile memory of claim 1, wherein
the calculation of the data logic circuit is at least an OR operation or an AND operation.

7. A non-volatile memory comprising:
a memory cell array including one or more non-volatile memory cells each configured to accumulate charge at two portions of an charge accumulation layer, the two portions corresponding to a first bit and a second bit;
an address decoder configured to select one of the memory cells from the memory cell array;
a write driver configured to write data to the selected memory cell;
a sense amplifier configured to read out data from the selected memory cell;
a buffer configured to supply write data to the write driver;
a register configured to hold an output of the buffer;
a second data switch configured to select one of an output of the register and an output of the sense amplifier;
a data logic circuit configured to perform a calculation on the output of the buffer and an output of the second data switch; and
a first data switch configured to select and input one of the output of the data logic circuit and the external data to the buffer.

8. A non-volatile memory comprising:
a memory cell array including one or more non-volatile memory cells each configured to accumulate charge at two portions of an charge accumulation layer, the two portions corresponding to a first bit and a second bit;
an address decoder configured to select one of the memory cells from the memory cell array;
a write driver configured to write data to the selected memory cell;
a sense amplifier configured to read out data from the selected memory cell;
a first buffer configured to supply write data to the write driver;
a second buffer configured to store external data;
a third data switch configured to select one of an output of the second buffer and an output of the sense amplifier;
a fourth data switch configured to select one of an output of the first buffer and the external data; and
a data logic circuit configured to perform a calculation on an output of the third data switch and an output of the fourth data switch, and output a result of the calculation to the first buffer.

9. A non-volatile memory comprising:
a memory cell array including one or more non-volatile memory cells each configured to accumulate charge at two portions of an charge accumulation layer, the two portions corresponding to a first bit and a second bit;
an address decoder configured to select one of the memory cells from the memory cell array;
a write driver configured to write data to the selected memory cell;
a sense amplifier configured to read out data from the selected memory cell;
a first buffer and a second buffer;
a fifth data switch configured to select and input one of an output of the first buffer and an output of the second buffer, as write data, to the write driver;
a sixth data switch configured to select one of external data, an output of the sense amplifier, and the output of the first buffer;
a seventh data switch configured to select one of the external data, the output of the sense amplifier, and the output of the second buffer;
a data logic circuit configured to perform a calculation on an output of the sixth data switch and an output of the seventh data switch; and
an eighth data switch configured to select and output one of an output of the data logic circuit and the external data to the first buffer and the second buffer.

10. The non-volatile memory of claim 7, wherein
the non-volatile memory cell accumulates charge at two portions of the charge accumulation layer, the two portions corresponding to a first bit and a second bit, and
data stored in the buffer at a time corresponds to one of the first and second bits.

11. The non-volatile memory of claim 7, wherein
the calculation of the data logic circuit is
an OR operation where a logical value stored in the buffer and pulse application are represented by “0,” and a read logical state of the sense amplifier and a write state are represented by “0,” or
an AND operation where a logical value stored in the buffer and pulse application are represented by “1,” and a read logical state of the sense amplifier and a write state are represented by “1.”
